(19) United States
(12) Patent Application Publication
(10) Pub. No.: US 2026/0370023 A1
(43) Pub. Date: Nov. 19, 2026

(54) Modular Charging Device; Charging Module for a Modular Charging Device

(71) Applicant: Robert Bosch GmbH, Stuttgart (DE)

(72) Inventor: Torsten Koller, Leinfelden-Echterdingen (DE)

(21) Appl. No.: 19/677,102

(22) Filed: May 14, 2026

(30) Foreign Application Priority Data
May 15, 2025 (DE) 10 2025 118 901.3

(51) Int. Cl. H02J 7/70; H02J 7/40; H02J 7/50; H02J 50/10

(52) U.S. Cl. CPC H02J 7/731; H02J 7/40; H02J 7/50; H02J 50/10

(57) ABSTRACT

A modular charging device includes a housing with a power plug for connecting the modular charging device to a power grid. The modular charging device has at least one module interface for mechanically and/or electrically connecting the housing to a module. A first module is configured as a charging module.

This application claims priority under 35 U.S.C. § 119 to patent application no. DE 10 2025 118 901.3, filed on May 15, 2025 in Germany, the disclosure of which is incorporated herein by reference in its entirety.

### BACKGROUND

German Patent Application DE 10 2016 205 773 A1 describes a charging device for electrically charging two battery packs.

### SUMMARY

The disclosure relates to a modular charging device having a housing with a power plug for connecting the modular charging device to a power grid. It is proposed that the modular charging device has at least one module interface for mechanically and/or electrically connecting the housing to a module, wherein a first module is configured as a charging module. This advantageously ensures the flexibility, expandability and adaptability of the charging device to future requirements and technologies through the standardized module interface.

The modular charging device has electronics that are preferably arranged within the charging device’s housing. The electronics comprise, in particular, an assembly for improving the power factor correction (PFC) and/or an EMC (electromagnetic compatibility) unit. To this end, the electronics comprise, in particular, at least one PFC controller IC that controls the power factor correction, as well as corresponding passive components such as coils and capacitors. The EMC unit has, in particular, filters and shielding designed to suppress unwanted high-frequency signals, such as decoupling capacitors, decoupling chokes, shielding plates, etc. Consequently, the charging modules do not have PFC or EMC functionalities or components and can therefore be provided in a more compact and/or cost-effective manner.

Each charging module may be designed for battery packs used in different devices or device categories. For example, the battery pack may be designed for a hand-held power tool rechargeable battery pack, a household appliance, an electric vehicle, an electric bicycle, etc. The battery pack is preferably designed as an exchangeable rechargeable battery pack, wherein the exchangeable rechargeable battery pack is disconnected from the device for charging and connected to the charging module of the modular charging device via a mechanical and electrical interface. The battery pack has a housing wherein at least one rechargeable battery cell is housed, and the housing is designed as an outer housing.

The modular charging device is designed to charge or supply power to the battery pack while it is connected. In the context of this application, a power plug is specifically understood to mean a plug connector that serves to connect the charging device to the power grid and provide the electrical power required for the charging process. For example, the power plug may be designed as a plug permanently installed on the device or as a replaceable plug. A permanently installed plug is cost-effective and robust. A replaceable plug, on the other hand, offers the possibility of equipping the charging device with different plug types for various outlet systems. This increases the charging device’s international usability and offers the user greater convenience.

The housing of the modular charging device may be made of a metallic material and/or plastic. The housing is designed as an outer housing. The housing may have one or more support surfaces on which it can be positioned during operation. The support surfaces are preferably flat. Furthermore, the housing may have a fastening mechanism configured to fasten the charging device to a wall or other suitable surfaces, such as a table, a shelf, or the interior of a vehicle. The fastening mechanism may, for example, be in the form of screw holes, clips, rails, or magnets.

The charging module has a battery interface designed for mechanical and electrical connection to a battery pack intended for that purpose. The battery interface of the charging module is designed to provide a mechanical and electrical connection between the charging device and the battery pack. The charging module may have one or more battery interfaces, such as two or six. The battery interfaces may be arranged, for example, side by side, in a row, symmetrically, etc.

The modular charging device preferably comprises at least two module interfaces. This allows for the simultaneous connection of two or more modules, thereby expanding the charging device’s functionality and flexibility. For example, two battery packs can be charged at the same time, or one battery pack can be charged while another device is powered simultaneously. Preferably, each module interface comprises a mechanical and an electrical interface. Alternatively, it is also conceivable that at least one module interface is designed as a purely mechanical module interface. The mechanical interface may be provided for tool-assisted connection or for tool-free connection of the module. This can be achieved, for example, through plug connectors, snap-fit mechanisms, screw connections, clamp connections, or a combination of these methods. A tool-free connection offers the advantage of allowing for quick and easy module replacement, while a tool-assisted connection can ensure greater stability and safety, particularly in applications involving strong vibrations or shocks. The electrical interfaces are preferably designed to be essentially identical. This simplifies manufacturing and reduces costs, as all modules can use the same connection. Additionally, it makes handling easier for the user, as all modules can be connected to any module interface. However, it is also conceivable that at least one module interface features a higher-performance design. This can be achieved, for example, by using contacts with a larger cross-section, implementing a separate power supply for high-power modules, or using special plug connectors capable of transmitting higher currents. This allows modules with higher power requirements to be connected and operated without overloading the other modules or the charging device.

It is further proposed that the housing has a control unit for controlling the module interfaces and/or a wireless communication unit. This can significantly enhance the functionality and user-friendliness of the charging device. The control unit is specifically designed to monitor the charging process, adjust the charging parameters to the respective battery type, and/or display the charging status. The control system may be configured such that the module interfaces are driven in parallel or in series to optimally distribute the charging power among the connected modules or to set charging priorities. With parallel control, all modules receive the full charging power simultaneously, whereas with serial control, the modules are charged one after the other. This can be useful, for example, when the total available power is limited. The wireless communication unit is specifically designed for connection to a mobile terminal device, such as a smartphone. This allows the user to be informed of the charging status, set charging parameters, or remotely control the charging process. For example, the app on the smartphone may be configured to display the current charge level of the connected batteries, send notifications when the charging process is complete, and/or adjust the charging power. This increases convenience and control over the charging process.

It is further proposed that the modular charging device has at least one fastening mechanism configured to fasten it to a wall or inside a toolbox. This advantageously increases flexibility and convenience for the user, particularly in mobile applications. The fastening mechanism for the toolbox may, for example, be designed as a built-in rail, a clip system, a magnetic closure, or a combination of these mechanisms. A built-in rail enables stable and secure fastening, while a clip system allows for quick and easy installation and removal of the modular charging device. A magnetic closure offers particularly convenient handling.

In addition, the disclosure relates to a system having a modular charging device as described above and at least a first module. Advantageously, the combination of the charging device and the modules results in a flexible and expandable system that can be adapted to the user’s individual needs.

Furthermore, it is proposed that the system has a second module, wherein the second module is configured as an anti-theft module. This advantageously enhances the security of the charging device and the connected devices. The anti-theft module can, for example, be used to protect the charging device or the connected rechargeable batteries from theft. The anti-theft module preferably has a position sensor, such as a GNSS receiver, and/or a wireless communication interface, such as a short-range or long-range communication interface. The wireless communication interface enables communication with the user, for example via a terminal device, or with a monitoring center. For example, an alarm can be triggered if the modular charging device is moved, or the charging device’s location can be tracked via an app on a smartphone. A short-range communication interface, such as Bluetooth, is suitable for communication in the vicinity of the charging device, while a long-range communication interface, such as cellular networks, enables location tracking and monitoring even over greater distances.

It is further proposed that the system has a third module designed as a purely mechanically connected module. For example, the third module may be designed as a cup holder or as a holder for insert tools or construction materials, such as screws or the like. Advantageously, this allows the charging device's functionality to be expanded and tailored to the user's needs.

It is also proposed that the system has at least two initial modules, wherein the charging modules differ, in particular, mechanically, within a charging interface. This advantageously allows different types of battery packs to be connected to the modular charging device. This increases the flexibility and compatibility of the system, as various battery systems can be charged without adapters or special charging devices. The mechanical charging interface can, for example, be designed to accommodate slide-in batteries, plug-in batteries, cylindrical batteries, or other battery types. Adapting the mechanical charging interface to the respective battery type ensures a secure and reliable connection. Additionally, the mechanical charging interface may also have special safety mechanisms.

It is further proposed that one charging module be configured as a charging contact interface with at least two electrical contact elements, and that another charging module be configured as a wireless charging interface. This has the advantage of allowing both rechargeable batteries with charging contacts and rechargeable batteries with wireless charging technology to be charged. This increases the charging device’s flexibility and compatibility and enables the use of various battery types without an adapter. The wireless charging interface can, for example, be designed as an induction coil compliant with the Qi standard. The charging contact interface may, for example, feature a spring contact strip or a socket strip. Spring contact strips provide flexible and reliable contact, while socket strips ensure a robust and durable connection. The contact elements may, for example, be designed as spring pins, socket contacts, or metal plates.

It is also proposed that the charging modules differ in their charging voltage. For example, the charging voltage can be adapted to different battery types, such as 3.6 V, 7.2 V, 12 V, 18 V, 24 V, 36 V, 48 V, or 80 V. By using charging modules with different charging voltages, batteries with different nominal voltages can be optimally charged.

Furthermore, it is proposed that the charging modules differ in their charging current. Advantageously, the charging time can be adapted to the battery’s capacity and the charging device’s performance.

Additionally, it is also conceivable that the module is configured as a load, for example as a lighting device, a radio, a hotplate, or a coffee maker. Other loads, such as a fan, a heating plate, a USB charging connector, a display, a speaker, a power tool, or a combination of these loads, are also conceivable. By integrating various loads into the modular system, the functionality and utility of the charging device are significantly expanded.

### BRIEF DESCRIPTION OF THE DRAWINGS

Further advantages follow from the description of the drawings below. The drawings, the description, and the claims contain numerous features in combination. A person skilled in the art will also appropriately consider the features individually and combine them into further meaningful combinations.

It shows:

FIG. 1 a schematic view of a modular charging device connected to six modules;

FIG. 2 a perspective view of a first charging module;

FIG. 3 a perspective view of a second charging mode;

FIG. 4 a perspective view of a third charging module;

FIG. 5 a perspective view of an anti-theft device of a second module;

FIG. 6 a perspective view of a third module;

FIG. 7 a perspective view of a fourth module.

### DETAILED DESCRIPTION

In FIG. 1, a schematic view of a modular charging device 10 is shown. The modular charging device 10, for example, has six module interfaces 12 that are designed to electrically and mechanically connect modules 14 to the housing 16 of the modular charging device 10. The modular charging device 10 has a power plug 18 designed to connect the modular charging device 10 to a power grid. The power grid is, for example, a 230 V power grid.

The power plug 18 is connected to the housing 16 of the modular charging device 10, for example, via a cable connection 20.

The housing 16 of the modular charging device 10 is, for example, rail-shaped. The module interfaces 12 are, for example, essentially identical in design and, for electrical connection, for example, feature three electrical contact elements, wherein two electrical contact elements are designed for power supply and one electrical contact element is designed for data exchange. The module interfaces 12 are also evenly spaced so that each module 14 has the same amount of space available. In addition, the housing 16 of the modular charging device 10 has a fastening mechanism (not shown) configured to fasten the housing 16 in a toolbox (not shown).

Electronics 22 are housed within the housing 16 of the modular charging device 10, wherein the electronics 22 has a power factor 24, for example in the form of a PFC controller IC, and an EMC unit 26, for example in the form of a noise-suppression capacitor. Consequently, these electronic components can advantageously be omitted from the individual modules 14. The electronics 22 are associated with a control unit 23, which is configured for open-loop or closed-loop control of the modular charging device 10.

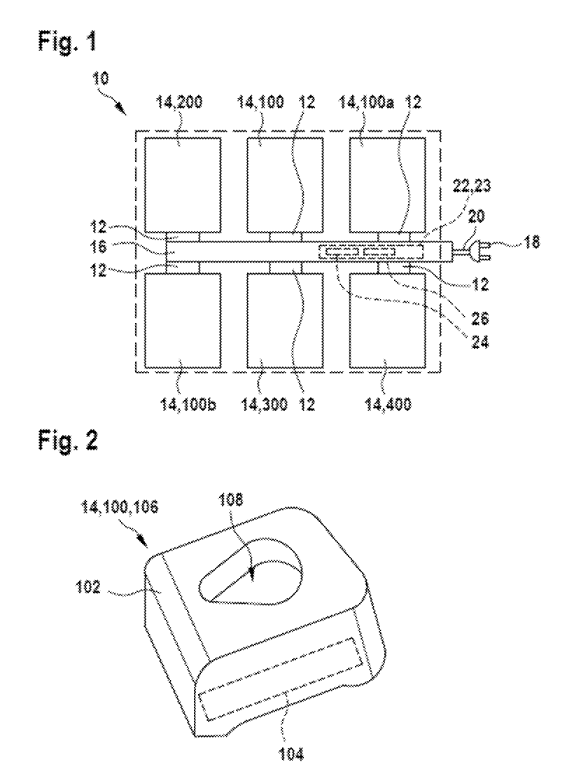

The modular charging device is connected, for example, to six modules 14, which are shown in FIGS. 2-7 and described in more detail below.

FIG. 2 shows a first module 100 in a perspective view. The first module 100 has a housing 102. The first module 100 is designed to be electrically and mechanically connectable to the modular charging device 10 via a module interface 104, specifically a module interface 12 of the modular charging device 10.

The first module 100 is configured as a charging module 106. The charging module 106 is configured to charge a battery pack (not shown). By way of example, the charging module 106 has a charging contact interface 108 configured to receive and electrically connect the plug-in battery pack (not shown). For this purpose, the charging contact interface 108 has an opening in the housing 102 of the charging module 106. The charging module 106 is configured, for example, to charge at a charging voltage of 12 V and a charging current of 4 A.

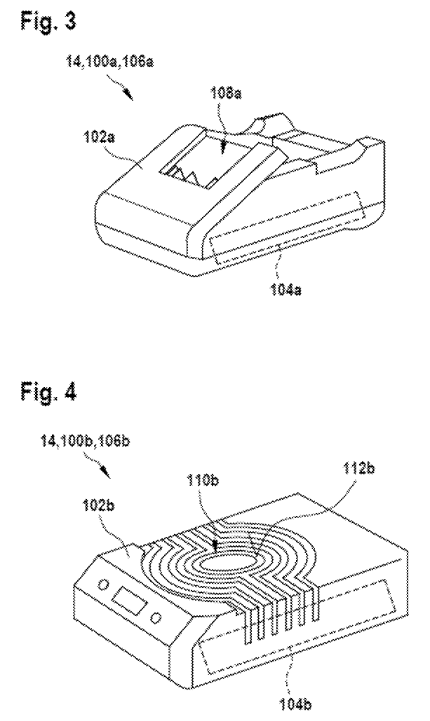

FIG. 3 shows another first module 100a, which is configured as a charging module 106a. The charging module 106a also has a housing 102a with a module interface 104a and a charging contact interface 108a, wherein the charging contact interface 108a is configured for electrical and mechanical connection to a second slide-on battery pack (not shown). The charging module 106a is configured, for example, to charge at a charging voltage of 18 V and a charging current of 8 A.

FIG. 4 shows another first module 100b, which is configured as a charging module 106b. The charging module 106b also comprises a housing 102b with a module interface 104b and a wireless charging interface 110b, wherein the wireless charging interface 110b is configured solely for electrical connection to a third battery pack (not shown). A charging coil (not shown) and electronics for controlling the charging coil are arranged within the housing 102b of the first charging module 106b. The wireless charging interface 110b has a support surface 112b for the battery pack on an outer side of the housing 102b, onto which the battery pack can be placed for automatic charging.

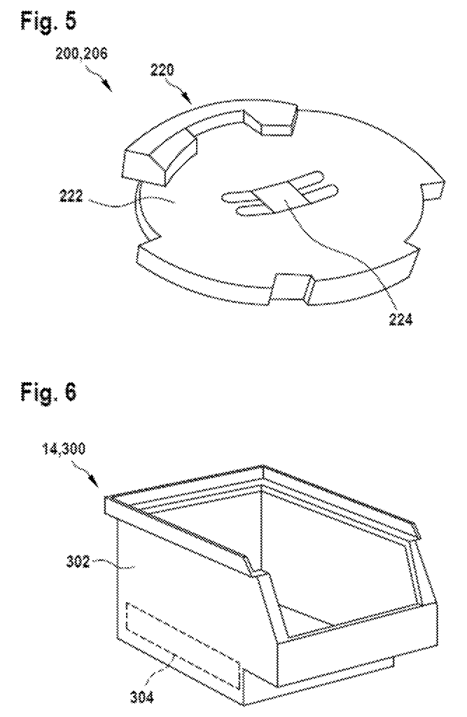

FIG. 5 shows a component of a second module 200 in a perspective view. The second module 200 is configured as an anti-theft module 206. The anti-theft module 206 has an anti-theft device 220, which is exemplarily configured to be detachably connected to a module housing (not shown). The anti-theft device 220 has a printed circuit board 222 that has a GNSS receiver and a wireless communication interface. The wireless communication interface is, for example, configured as a cellular communication interface. In addition, the printed circuit board 222 has a battery interface 224 designed to connect to a battery (not shown). This also allows for theft protection even when the modular charging device 10 is not connected to the power grid. The second module 200 likewise has a module interface (not shown) configured for the electrical and mechanical connection of the second module 200.

FIG. 6 shows a third module 300 in a perspective view. The third module 300 has a housing 302 designed to hold material, insert tools, or other small parts. The housing 302 is, for example, shaped like a compartment and has a module interface 304 on its bottom side, which is designed for mechanical connection to a module interface 12 of the modular charging device 10. The connection is, for example, purely mechanical, since the third module 300 has no electrical function.

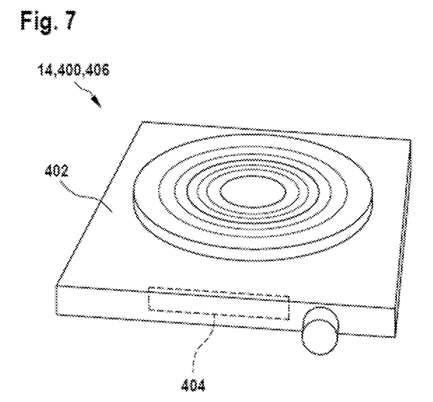

FIG. 7 shows a fourth module 400 in a perspective view. The fourth module 400 has a housing 402 and is, for example, designed as a consumer 406 in the form of a hotplate. The fourth module 400 has a module interface 404 on a bottom side of the housing 402, wherein it is also conceivable that the module interface 404 of the module 400 is connected to the housing 402 via a cable, so that the consumer 406 can also be used at a distance from the modular charging device.

What is claimed is:

1. A modular charging device, comprising:
a housing;
a power plug attached to the housing and configured to connect the modular charging device to a power grid;
a first module configured as a charging module; and
at least one module interface configured to mechanically and/or electrically connect the first module to the housing.

2. The modular charging device according to claim 1, wherein the housing has a control unit configured to control the at least one module interface and/or a wireless communication unit.

3. The modular charging device according to claim 1, further comprising at least one fastening mechanism configured to fasten the modular charging device to a wall or inside a toolbox.

4. A system, comprising:
a housing;
a first charging module;
a power plug attached to the housing and configured to connect the first charging module to a power grid; and
a number of module interfaces including a first module interface which is configured to mechanically and/or electrically connect the first charging module to the housing.

5. The system according to claim 4, further comprising a second module, wherein the second module is configured as an anti-theft module.

6. The system according to claim 5, further comprising a third module configured as a purely mechanically connected module.

7. The system according to claim 4, further comprising a second charging module, wherein:
the number of module interfaces includes a second module interface,
the second module interface is configured to mechanically and/or electrically connect the second charging module to the housing,
the first charging module and the second charging module are configured to differ mechanically.

8. The system according to claim 7, wherein:
the first charging module has a charging contact interface with at least two electrical contact elements, and
the second charging module is configured as a wireless charging module.

9. The system according to claim 7, wherein the first charging module and the second charging module are configured to differ in their charging voltage.

10. The system according to claim 7, wherein the first charging module and the second charging module are configured to differ in their charging current.
